(19) United States
(12) Patent Application Publication
(10) Pub. No.: US 2024/0174103 A1
(43) Pub. Date: May 30, 2024

(54) AIR GUIDING DEVICE, CLIMATE CONTROL DEVICE AS WELL AS CHARGING STATION COMPRISING SUCH AN AIR GUIDING DEVICE AND SUCH A CLIMATE CONTROL DEVICE

(71) Applicant: ads-tec Energy GmbH, Nürtingen (DE)

(72) Inventors: Andreas GREIF, Weilheim (DE); Roman MOLCHANOV, Neckartenzlingen (DE); Johannes SCHUCHTER, Grasbrunn (DE); Simon BAREIß, Rudersberg (DE)

(21) Appl. No.: 18/511,252

(22) Filed: Nov. 16, 2023

(30) Foreign Application Priority Data
Nov. 24, 2022 (DE) 102022131169.4

(51) Int. Cl. B60L 53/302; H05K 7/20

(52) U.S. Cl. CPC B60L 53/302; H05K 7/2089

(57) ABSTRACT

The invention relates to an air guiding device for a climate control device of a charging station for electric vehicles, whereby
the air guiding device has a first base surface, a second base surface located opposite the first base surface, and a jacket surface connecting the first base surface and the second base surface, whereby the first base surface, the second base surface, and the jacket surface enclose an air guiding space, whereby
an air region separating element, which divides the air guiding space into an air inlet space and into an air outlet space, is arranged in the air guiding space, whereby
the jacket surface has, on a first side assigned to the air inlet space, an air inlet opening, and has, on a second side assigned to the air outlet space, an air outlet opening, whereby
in the air inlet space, the first base surface has an air outlet connection and an air inlet connection in the air outlet space, so that
the air inlet opening is fluidically connected via the air inlet space to the air outlet connection and the air outlet opening is fluidically connected via the air outlet space to the air inlet connection.

The invention additionally relates to a climate control device for the connection to such an air guiding device and
a charging station comprising such an air guiding device and comprising such a climate control device.

The invention relates to an air guiding device for a climate control device of a charging station for electric vehicles, a climate control device, and a charging station.

Advancements in the development of battery storages provide for a higher electrical capacity with in particular consistent installation space of the battery storage. As a result, battery storages with a higher electrical capacity can be installed in electric vehicles.

The users of electric vehicles usually expect a quick charging of the battery storage, in order to be able to continue driving promptly and are thus not necessarily willing to stay longer at the charging station due to a battery storage, which has a larger electrical capacity.

As a result, it is necessary that a charging power for charging the battery storage is increased. An increase of the charging power is in particular accompanied by an increase of the charging current and the charging voltage. The heat created thereby in the charging station is usually dissipated by a climate control device of the charging station.

Ambient air is thereby supplied to the climate control device, in particular for cooling purposes. The air heated in the climate control device is subsequently dissipated into the surrounding area again.

Due to the higher heat development in the charging station, it is necessary to provide a climate control system with a higher cooling capacity. This is usually accompanied by an enlargement of an installation space of the climate control device. An enlargement of the installation space of the climate control device, however, is undesirable due to the limited installation space in the charging station.

The climate control device further requires a higher volume flow of the ambient air in order be able to cool the charging station as intended. This is usually accompanied by an enlarged air inlet opening and air outlet opening as well as an enlarged air guiding device in the charging station, so that sufficient ambient air can be supplied to the climate control device.

In the case of an enlarged air inlet opening and air outlet opening, however, there is the risk that splash water, in particular in case of rain, storm or when cleaning the charging station, penetrates into the charging station. An enlarged air inlet opening and air outlet opening further promotes a noise emission of the charging station, which, in turn, negatively impacts the well-being of a user or of residents. An enlargement of the installation space of the air guiding device is likewise ruled out due to the limited installation space in the charging station.

The invention is thus based on the object of creating an air guiding device for a climate control device of a charging station for electric vehicles, a climate control device and a charging station, whereby the mentioned disadvantages are reduced, preferably do not occur.

The object is solved in that the present technical teaching is provided, in particular the teaching of the independent claims as well as of the preferred embodiments disclosed in the dependent claims and the description.

The object is solved in particular in that an air guiding device for a climate control device of a charging station for electric vehicles is created. The air guiding device has a first base surface, a second base surface located opposite the first base surface, and a jacket surface connecting the first base surface and the second base surface. The first base surface, the second base surface, and the jacket surface enclose an air guiding space. An air region separating element, which divides the air guiding space into an air inlet space and into an air outlet space, is arranged in the air guiding space. On a first side assigned to the air inlet space, the jacket surface has an air inlet opening and an air outlet opening on a second side assigned to the air outlet space—in particular located opposite the first side. In the air inlet space, the first base surface has an air outlet connection and an air inlet connection in the air outlet space, so that the air inlet opening is fluidically connected via the air inlet space to the air outlet connection and the air outlet opening is fluidically connected via the air outlet space to the air inlet connection. Advantageously, a particularly compact air guiding device is provided in this way. Advantageously, the air inlet opening and the air outlet opening are in particular arranged on opposite sides, so that exhaust air, which escapes from the air outlet opening and which is in particular heated by means of the climate control device, is not sucked in again. The air guiding device can in particular be arranged in a charging station in such a way that the in particular more noise-intensive air outlet opening is arranged on a side of the charging station facing away from a user. The user advantageously experience is in particular not negatively impacted thereby.

The jacket surface is in particular formed of four partial jacket surfaces, namely a first partial jacket surface and a third partial jacket surface located opposite the first partial jacket surface as well as a second partial jacket surface and a fourth partial jacket surface located opposite the second partial jacket surface. The air guiding device is in particular formed in a box-shaped manner with the four partial jacket surfaces, the first base surface, and the second base surface. The air inlet opening is in particular arranged on the first partial jacket surface. The air outlet opening is in particular arranged on the third partial jacket surface.

In electrical engineering, any, in particular stationary or mobile device or electrical installation, which serves the purpose of supplying energy to mobile accumulator-operated equipment, machines, or motor vehicles, by means of a simple setting or plugging in, without inevitably having to remove the energy storage—for instance the traction battery of an electric vehicle—is referred to as charging station. Charging stations for electric vehicles are sometimes also referred to as “electricity charging stations” and can comprise several charging points. In particular direct current quick charging systems (high performance charging systems or high power charging systems, HPC systems) such as the so-called combined charging system (CCS), which is common in Europe, are known here. During the generic direct current charging, direct current from the charging station is fed directly into the battery of the vehicle and is, for this purpose, provided to, e.g., solar charging stations by means of a powerful rectifier, preferably of the charging station, from the power supply or by means of large buffer accumulators. A battery management system, which communicates directly or indirectly with the charging station, in order to adapt the current and voltage or to end the process when reaching a predetermined capacity limit, is located in the vehicle. Power electronics are thereby typically located in the charging station. Due to the fact that the DC connections of the charging station are connected directly—without detour via an AC/DC converter of the vehicle—to corresponding connections of the traction battery, high charging currents can be transferred with little loss, which provides for short charging times.

In one embodiment, the charging station is formed as a charging column. The charging station in particular has at least one charging point, in particular exactly one charging point or exactly two charging points.

The charging station is in particular formed as quick charging station. In one embodiment, the charging station is formed as battery-supported charging station, in particular as battery-supported quick charging station.

According to a further development of the invention, it is provided that the air outlet connection is configured to be releasably connected to an air entrance of the climate control device, whereby the air inlet connection is configured to be releasably connected to an air exit of the climate control device. The climate control device can fluidically be connected in a particularly flexible manner to the air guiding device in this way. The air in particular flows from the air let opening via the air inlet space to the air outlet connection, where it enters into the climate control device via the air entrance; it then flows through the climate control device, leaves it again via the air exit, where it enters into the air outlet space through the air inlet connection, in order to then escape from the air guiding device through the air outlet opening.

In the context of the present technical teaching, releasable means in particular releasable in a destruction-free manner.

The air outlet connection is in particular configured to be connected in a plug-free releasable manner, in particular in a screw-free releasable manner, in particular by means of relative shearing movement in a releasable manner, to the air entrance of the climate control device. Alternatively or additionally, the air inlet connection is configured to be connected in a plug-free releasable manner, in particular in a screw-free releasable manner, in particular by means of relative shearing movement in a releasable manner, to the air exit of the climate control device.

According to a further development of the invention, it is provided that the air guiding device is formed in some regions as a housing of the charging station or is formed by the housing. Advantageously, a particularly compact construction is made possible thereby.

According to a further development of the invention, it is provided that the second base surface is arranged on the air guiding device so as to be capable of being opened, in particular in order to be displaced from a closed position into an open position. Advantageously, the air guiding space, in particular the air inlet connection and the air outlet connection, can be accessed particularly easily for a maintenance and/or cleaning.

In one embodiment, the second base surface can be removed, in particular completely removed, from the air guiding device. The closed position is in particular a position, in which the second base surface is arranged on the air guiding device as intended, in particular in such a way that the second base surface encloses the air guiding space. The open position is in particular a position, in which the second base surface is removed, in particular completely removed, from the air guiding device, in particular in such a way that the second base surface no longer encloses, in particular releases, the air guiding space.

In another embodiment, the second base surface is arranged on the air guiding device so as to be capable of being folded. The closed position is in particular a position, in which the second base surface is folded closed, in particular in such a way that the second base surface encloses the air guiding space. The open position is in particular position, in which the second base surface is folded open, in particular in such a way that the second base surface no longer encloses, in particular releases, the air guiding space.

According to a further development of the invention, it is provided that an air opening, selected from the air inlet opening and the air outlet opening, has at least one fluid deflecting element. The at least one fluid deflecting element is arranged and formed in such a way that a fluid jet, which is directed—in particular partially or completely—at the air opening or which penetrates into the air opening, is directed away from the air opening or is directed out of the air opening, preferably in such a way that the fluid jet does not reach an air region, which is assigned to the air opening, selected from the air inlet space and the air outlet space. The air inlet space and the air outlet space are advantageously protected against splash water, in particular in case of rain or storm, in this way. It is further possible that an outer surface of the air guiding device, which is formed as housing, can be cleaned particularly easily, in particular by means of a high pressure cleaner. It is possible in an advantageous manner by means of the specifically arranged and formed fluid deflecting elements to be able to safely supply and discharge an air volume flow, which is necessary for the climate control device for climate control purposes.

At least two fluid deflecting elements of the at least one fluid deflecting element are in particular arranged and formed in such a way that a fluid jet impinging on the first fluid deflecting element of the at least two fluid deflecting elements is diverted in such a way that the fluid jet impinges, in particular partially or completely, on at least one further fluid deflecting element of the at least two fluid deflecting elements. The fluid jet is deflected out of the air opening in particular by means of the at least one further fluid deflecting element.

The object is also solved in that a climate control device for a charging station for the connection to an air guiding device according to the invention or an air guiding device according to one of several of the above-described embodiments is created. The climate control device has an air entrance, and air exit, and a climate control region, which is fluidically arranged between the air entrance and the air exit. The air entrance and the air exit are arranged on a same side of the climate control device. The air entrance is configured to be releasably connected to the air outlet connection of the air guiding device. The air exit is configured to be releasably connected to the air inlet connection of the air guiding device. Advantageously, a particularly compact climate control device is provided in this way. A particularly simple cooperation with the air guiding device is ensured by means of the air passages, which are arranged on a same side, that is, the air entrance and the air exit. In particular, the advantages, which have already been described in connection with the air guiding device, are realized.

The climate control device is in particular formed in a box-shaped manner.

According to a further development of the invention, it is provided that the climate control device has an air conditioning module, which is arranged in the climate control region and which in particular has an air drying module and a condensate separation module. The climate control device preferably has a circulating cooler module, which is configured to control the temperature of a fluid of a fluid cooling device of the charging station. Due to the compact integration of several modules, the climate control device can be used in a particularly flexible and installation space-saving manner. The climate control device is preferably configured in particular in order to provide two different cooling mechanisms for the charging station, namely, on the one hand, an air cooling, in particular for battery modules of the charging station, by means of the air conditioning module, as well as a liquid cooling, in particular for power electronics of the charging station, by means of the circulating cooler module.

The object is also solved in that a charging station comprising an air guiding device according to the invention or an air guiding device according to one or several of the above-described embodiments and comprising a climate control device according to the invention or an climate control device according to one or several of the above-described embodiments is created. The air guiding device and the climate control device are arranged adjacently, in particular directly, in the charging station—in particular geodetically one on top of the other—in such a way that the air outlet connection of the air guiding device can be releasably connected, in particular is releasably connected fluidically to the air entrance of the climate control device and that the air inlet connection of the air guiding device can be releasably connected, in particular is releasably connected fluidically to the air exit of the climate control device. In connection with the charging station, in particular the advantages result, which have already been described in connection with the air guiding device and the climate control device.

According to a further development of the invention, it is provided that the air guiding device is arranged in a roof region of the charging station in such a way that the second base surface forms an, in particular removable, housing cover of the housing of the charging station, which is arranged geodetically on the top. Alternatively, it is provided that the air guiding device is arranged in a bottom region of the charging station in such a way that the second base surface forms an, in particular removable, housing bottom of the housing of the charging station, which is arranged geodetically on the bottom. The air guiding space, in particular the air inlet connection and the air outlet connection, can advantageously be accessed particularly easily for a maintenance and/or cleaning in this way.

The second base surface forming the housing cover or housing bottom of the charging station in particular has a plurality of, in particular two or four, transport elements. The charging station can in particular be lifted by means of the transport elements by a lifting device, in particular by a crane or a forklift. The transport elements in each case in particular have an eye, a hook, or a Gabeleingriff, or are formed by an eye, a hook, or a Gabeleingriff.

According to a further development of the invention, it is provided that the climate control device is arranged in the charging station so as to be capable of being displaced by means of a displacing device. By means of the displacing device, the climate control device can be displaced, in particular locally, between an operating position arranged in the charging station and at least one maintenance position, which is arranged at least in some regions outside of the charging station. In the operating position, the air outlet connection is releasably connected fluidically to the air entrance, and the air inlet connection to the air exit. In the at least one maintenance position, the air outlet connection is released from the air entrance and the air inlet connection from the air exit, in particular fluidically separated. An inspection and a maintenance of the climate control device and of the charging station can advantageously take place particularly easily in this way. In the case of a necessary replacement, the climate control device can in particular be easily separated from the air guiding device and can be displaced out of the charging station. Advantageously, the climate control device, which is displaced out of the charging station, can be lifted particularly easily by a lifting device, in particular by a crane or a forklift.

The displacing device has in particular at least one telescopic rail or is formed by at least one telescopic rail. The displacing device in particular has two telescopic rails, which are located opposite one another and on which the climate control device is movably mounted.

The climate control device can in particular be displaced out of the charging station on both sides by means of the displacing device.

The climate control device can in particular be displaced into at least one intermediate position, which is arranged between the operating position and the at least one maintenance position, in particular as at least one further maintenance position.

According to a further development of the invention, it is provided that the air outlet connection and the air entrance are configured to be fluidically connected to one another during a displacement of the climate control device into the operating position, and in order to be released from one another, in particular fluidically separated, during a displacement of the climate control device into the operating position, and in order to be released from one another, in particular fluidically separated, during a displacement of the climate control device away from the operating position. The climate control device is fluidically connected particularly easily to the air guiding device in this way. A manual and time-consuming screwing of the respective connections is in particular forgone.

According to a further development of the invention, it is provided that a first sealing element is arranged between the air outlet connection and the air entrance, whereby the first sealing element is optionally fastened to the air outlet connection or to the air entrance. Alternatively or additionally, a second sealing element is arranged between the air inlet connection and the air exit, whereby the second sealing element is optionally fastened to the air inlet connection or to the air exit. A leakage in the air guiding device is advantageously reduced, preferably avoided, in this way.

At least one sealing element, selected from the first sealing element and the second sealing element, in particular has a sealing lip or a foam seal or is formed as a sealing lip or a foam seal.

According to a further development of the invention, it is provided that the air region separating element of the air guiding device is formed as a support structure of the charging station, which is configured to mechanically stabilize the charging station, in particular for lifting and/or for the transport. A particularly compact support structure is advantageously realized in this way. Due to the mechanical stabilization, the charging station can be lifted and transported easily and securely, in particular when the charging station is fitted with a plurality of energy storage modules or if a heat storage device of the charging station is filled, in particular completely filled, with a fluid.

According to a further development of the invention, it is provided that the air region separating element is arranged diagonally to the first base surface and/or the second base surface. The mechanical stabilization of the charging station is advantageously improved in this way, in particular a consistent force introduction is made possible.

The invention will be described in more detail below on the basis of the drawing, in which:

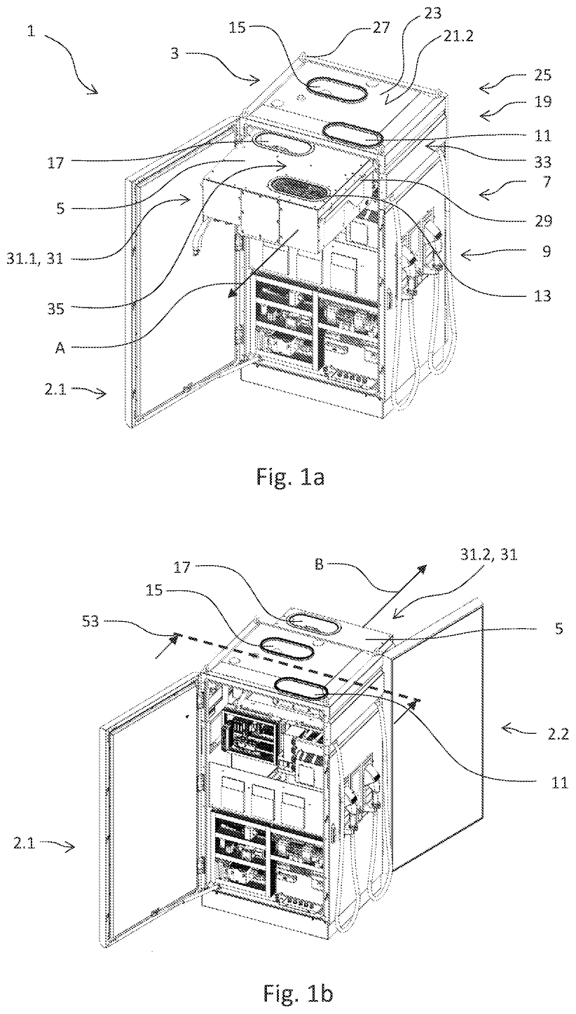

FIG. 1a shows a schematic illustration of a first state of an exemplary embodiment of a charging station with an exemplary embodiment of an air guiding device and with an exemplary embodiment of a climate control device,

FIG. 1b shows a schematic illustration of a second state of the charging station according to FIG. 1a,

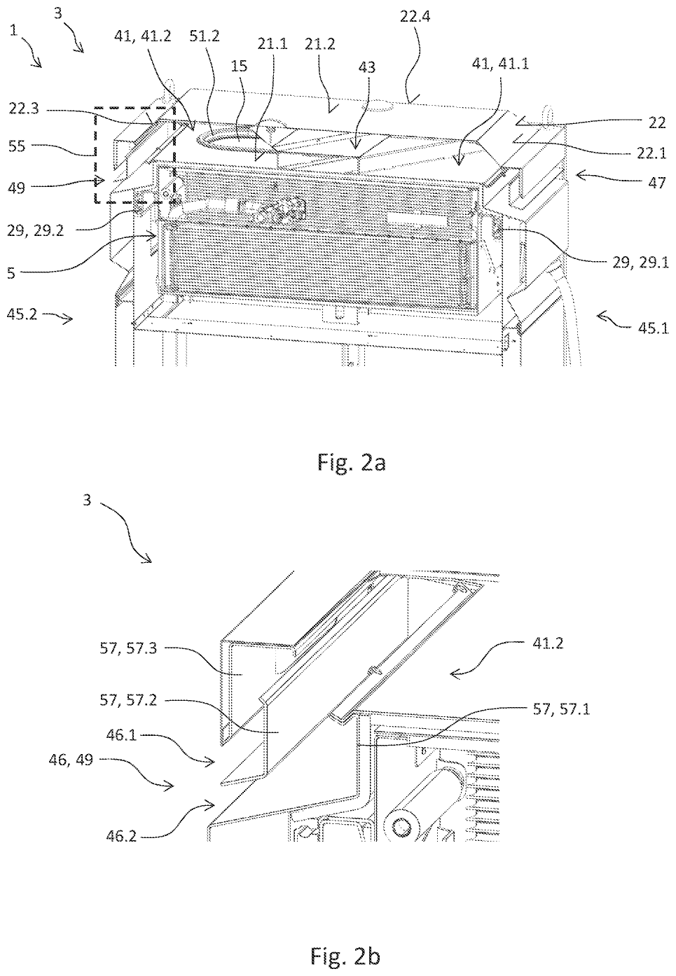

FIG. 2a shows a schematic illustration of a first sectional view of the first section of the charging station according to FIG. 1b,

FIG. 2b shows a schematic illustration of an enlarged view of a section according to FIG. 2a, and

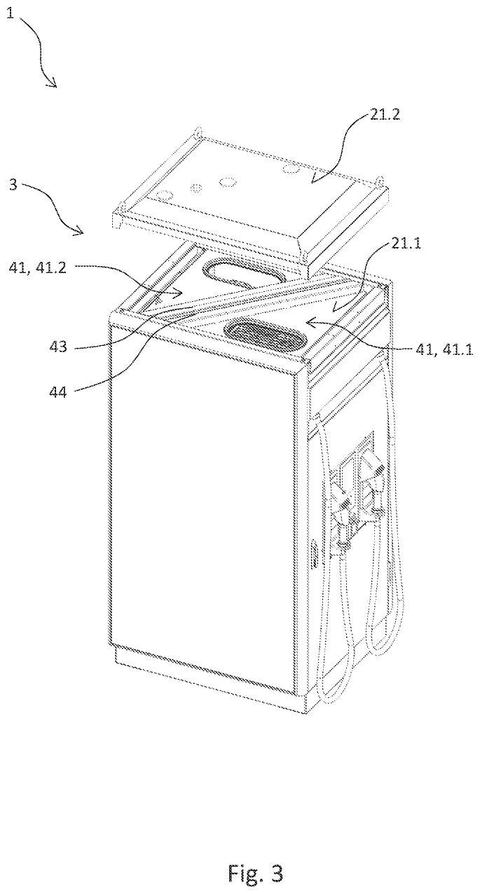

FIG. 3 shows a schematic illustration of a third state of the charging station according to FIG. 1a.

FIG. 1a shows a schematic illustration of a first state of an exemplary embodiment of a charging station 1 comprising an air guiding device 3 and comprising a climate control device 5.

In the first state, a first, in particular laterally arranged housing door 2.1 of the charging station 1 is open. On a front side 7, the charging station 1 has two charging plugs 9, by means of which an electric vehicle, which is not illustrated here, can be charged in each case.

The climate control device 5 has an air entrance 13, an air exit 17 and a climate control region 35, which is fluidically arranged between the air entrance 13 and the air exit 17. The air entrance 13 and the air exit 17 are arranged on a same side—here on a geodetically upper side—of the climate control device 5. The air entrance 13 is configured to be releasably connected to an air outlet connection 11 of the air guiding device 3, which is located on the inside and which is in fact illustrated here, but which is hidden from the observer in reality. The air exit 17 is configured to be releasably connected to an air inlet connection 15 of the air guiding device 3, which is located on the inside and which is in fact illustrated here, but which is hidden from the observer in reality. The climate control device 5 is preferably formed in a box-shaped manner.

It is preferably provided that the air guiding device 3 is formed in some regions as a housing 25 of the charging station 1 or is formed by the housing 25.

In this exemplary embodiment, the air guiding device 3 is arranged in a roof region 19 of the charging station 1 in such a way that a second base surface 21.2 forms a housing cover 23 of the housing 25 of the charging station 1, which is arranged geodetically on the top.

The second base surface 21.2 preferably has at least one transport element 27, here four eyes. The charging station 1 can preferably be lifted by means of the at least one transport element 27 by a lifting device, preferably by a crane or a forklift.

It is preferably provided that the climate control device 5 is arranged in the charging station 1 so as to be capable of being displaced by means of a displacing device 29. By means of the displacing device 29, the climate control device 5 can be displaced, preferably locally, between an, only suggested, operating position 33, which is arranged in the charging station 1, and at least one maintenance position 31, which is arranged at least in some regions outside of the charging station 1.

It is preferably provided that the air outlet connection air outlet connection 11 and the air entrance 13 are configured to be fluidically connected to one another during a displacement of the climate control device 5 into the operating position 33, and in order to be released from one another, preferably fluidically separated, during a displacement of the climate control device 5 away from the operating position 33. The air inlet connection 15 and the air exit 17 are configured to be fluidically connected to one another during a displacement of the climate control device 5 into the operating position 33, and in order to be released from one another, preferably fluidically separated, during a displacement of the climate control device 5 away from the operating position 33.

In the first state, the climate control device 5 is displaced into a first maintenance position 31.1 of the at least one maintenance position 31, which is arranged predominantly outside of the charging station 1, in a first direction illustrated by the arrow A. In the first maintenance position 31.1, the air outlet connection 11 is released from the air entrance 13 and the air inlet connection 15 is released from the air exit 17, preferably fluidically separated.

FIG. 1b shows a schematic illustration of a second state of the charging station 1 according to FIG. 1a.

Identical and functionally identical elements are thereby provided with identical reference numerals in all figures, so that reference is made to the preceding description in this respect.

In the second state, the first housing door 2.1 and a second housing door 2.2 located opposite the first housing door 2.1 are open.

In the second state, the climate control device 5 is displaced into a second maintenance position 31.2, which is only partially arranged outside of the charging station 1, of the at least one maintenance position 31 in a second direction, which differs from the first direction—in particular opposite thereto—and which is illustrated by the arrow B. In the second maintenance position 31.2, the air outlet connection 11, which is in fact illustrated here, but which is hidden from the observer in reality, is released, preferably fluidically separated, from the non-visible air entrance 13, and the air inlet connection 15, which is in fact illustrated here, but which is hidden from the observer in reality, is released, preferably fluidically separated, from the from the air exit 17.

A first longitudinal section 53 of the charging station 1 illustrated by means of dashes is described in FIG. 2a.

FIG. 2a shows a schematic illustration of a first sectional view of the first longitudinal section 53 of the charging station 1 according to FIG. 1b.

The climate control device 5 illustrated in FIGS. 1a and 1b is likewise visible here. The displacing device 29 can be seen in some regions with a first telescopic rail 29.1 and a second telescopic rail 29.2.

The air guiding device 3 has a first base surface 21.1, the second base surface 21.2 located opposite the first base surface 21.1, and a jacket surface 22. connecting the first base surface 21.1 and the second base surface 21.2. The first base surface 21.1, the second base surface 21.2, and the jacket surface 22 enclose an air guiding space 41. An air region separating element 43, which divides the air guiding space 41 into an air inlet space 41.1 and into an air outlet space 41.2, is arranged in the air guiding space 41. On a first side 45.1, which is assigned to the air inlet space 41.1, the jacket surface 22 has an air inlet opening 47, and an air outlet opening 49 on a second side 45.2, which is assigned to the air outlet space 41.2. In the air inlet space 41.1, the first base surface 21.1 has the air outlet connection 11, which is not illustrated here, and the air inlet connection 15 in the air outlet space 41.2, so that the air inlet opening 47 is fluidically connected via the air inlet space 41.1 to the air outlet connection 11, and the die air outlet opening 49 is fluidically connected via the air outlet space 41.2 to the air inlet connection 15.

The jacket surface 22 is preferably formed of four partial jacket surfaces, namely of a first partial jacket surface 22.1 and a third partial jacket surface 22.3, which is located opposite the first partial jacket surface 22.1, as well as of a second partial jacket surface, which is not visible and which emerge from the image plane, and of a fourth partial jacket surface 22.4, which is located opposite the second partial jacket surface 22.2. The air guiding device 3 is preferably formed in a box-shaped manner by means of the four partial jacket surfaces, the first base surface 21.1 and the second base surface 21.2. The air inlet opening 47 is preferably arranged on the first partial jacket surface 22.1. The air outlet opening 49 is preferably arranged on the third partial jacket surface 22.3.

It is preferably provided that a first sealing element, which is not visible here, is arranged between the air outlet connection 11 and the air entrance 13, whereby the first sealing element 51.1 is optionally fastened to the air outlet connection 11 or to the air entrance 13. A second sealing element 51.2 is arranged between the air inlet connection 15 and the air exit 17, whereby the second sealing element 51.2 is optionally fastened to the air inlet connection 15 or to the air exit 17.

In this exemplary embodiment, the non-visible first sealing element 51.1 is fastened to the air outlet connection 11 and the second sealing element 51.2 is fastened to the air inlet connection 15.

A section 55, which is illustrated in a dashed manner, is described in FIG. 2b.

FIG. 2b shows a schematic illustration of an enlarged view of the section 55 according to FIG. 2a.

The enlarged view shows the air outlet opening 49 of the air guiding device 3. The following description accordingly also applies for the air inlet opening 47, which is not illustrated here.

It is preferably provided that an air opening 46, selected from the air inlet opening 47 and the air outlet opening 49, has at least one fluid deflecting element 57. The at least one fluid deflecting element 57 is arranged and formed in such a way that a fluid jet, which is directed, preferably partially or completely, at the air opening 46 or which penetrates into the air opening 46, is directed away from the air opening 46 or is directed out of the air opening 46, preferably in such a way that the fluid jet does not reach an air region, which is assigned to the air opening 46, selected from the air inlet space 41.1 and the air outlet space 41.2.

The air opening 46 shown here has a first fluid deflecting element 57.1, a second fluid deflecting element 57.2, and a third fluid deflecting element 57.3. The air opening 46 is further formed by a first partial air opening 46.1, which is arranged geodetically above, and a second partial air opening 46.2, which is arranged geodetically below.

A fluid jet penetrating into the first partial air opening 46.1 is directed away by the second fluid deflecting element 57.2 in such a way that the fluid jet impinges on the third fluid deflecting element 57.3 and subsequently escapes from the air opening 46.

A fluid jet penetrating into the second partial air opening 46.2 is directed away by the first fluid deflecting element 57.1 in such a way that the fluid jet impinges on the second fluid deflecting element 57.2 and subsequently escapes from the air opening 46.

FIG. 3 shows a schematic illustration of a third state of the charging station 1 according to FIG. 1a.

It is preferably provided that the second base surface 21.2 is arranged on the air guiding device 3 so as to be capable of being opened, in order to preferably be displaced from a closed position into an open position.

In this exemplary embodiment, the second base surface 21.2 can be removed, preferably completely removed, from the air guiding device 3.

It is preferably provided that the air region separating element 43 of the air guiding device 3 is formed as a support structure 44 of the charging station 1, which is configured to mechanically stabilize the charging station 1, preferably for lifting and/or for the transport.

It is preferably provided that the air region separating element 43 is arranged diagonally to the first base surface 21.1 and/or the second base surface 21.2.

It can be seen particularly well here, how the air region separating element 43, which is formed as support structure 44, divides the air guiding space 41 into the air inlet space 41.1 and the air outlet space 41.2.

1. An air guiding device for a climate control device of a charging station for electric vehicles, whereby
the air guiding device has a first base surface, a second base surface located opposite the first base surface, and a jacket surface connecting the first base surface and the second base surface, whereby the first base surface, the second base surface, and the jacket surface enclose an air guiding space, whereby
an air region separating element, which divides the air guiding space into an air inlet space and into an air outlet space, is arranged in the air guiding space, whereby
the jacket surface has, on a first side assigned to the air inlet space, an air inlet opening, and has, on a second side assigned to the air outlet space, an air outlet opening, whereby
the first base surface has, in the air inlet space, an air outlet connection, and has, in the air outlet space, an air inlet connection, so that
the air inlet opening is fluidically connected via the air inlet space to the air outlet connection and the air outlet opening is fluidically connected via the air outlet space to the air inlet connection.

2. The air guiding device according to claim 1, whereby
the air outlet connection is configured to be releasably connected to an air entrance of the climate control device, whereby
the air inlet connection is configured to be releasably connected to an air exit of the climate control device.

3. The air guiding device according to claim 1, whereby the air guiding device is formed in some regions as a housing of the charging station or is formed by the housing.

4. The air guiding device according to claim 1, whereby the second base surface is arranged on the air guiding device so as to be capable of being opened.

5. The air guiding device according to claim 1, whereby
an air opening, selected from the air inlet opening and the air outlet opening, has at least one fluid deflecting element, whereby
the at least one fluid deflecting element is arranged and formed in such a way that a fluid jet, which is directed at the air opening or which penetrates into the air opening is directed away from the air opening or is directed out of the air opening, preferably in such a way
that the fluid jet does not reach an air region, which is assigned to the air opening, the air region being selected from the air inlet space and the air outlet space.

6. A climate control device for connecting to an air guiding device according to claim 1 for a charging station, whereby the climate control device has an air entrance, an air exit, and a climate control region, which is fluidically connected between the air entrance and the air exit, whereby
the air entrance and der air exit are arranged on a same side of the climate control device, whereby
the air entrance is configured to be releasably connected to the air outlet connection of the air guiding device, whereby
the air exit is configured to be releasably connected to the air inlet connection of the air guiding device.

7. The climate control device according to claim 6, having
an air conditioning module, which is arranged in the climate control region and which in particular has an air drying module and a condensate separation module, and preferably
a circulating cooler module, which is configured to control the temperature of a fluid of a fluid cooling device of the charging station.

8. A charging station comprising: an air guiding device and a climate control device, whereby
the air guiding device and the climate control device are adjacently arranged in the charging station in such a way that
the air outlet connection of the air guiding device is releasably connected fluidically to the air entrance of climate control device, and that
the air inlet connection of the air guiding device is releasably connected fluidically to the air exit of the climate control device.

9. The charging station according to claim 8, whereby
the air guiding device is arranged in a roof region of the charging station in such a way that the second base surface forms a housing cover of the housing of the charging station, which is arranged geodetically on the top, or
the air guiding device is arranged in a bottom region of the charging station in such a way that the second base surface forms a housing bottom of the housing of the charging station, which is arranged geodetically on the bottom.

10. The charging station according to claim 8, whereby
the climate control device is arranged in the charging station so as to be capable of being displaced by means of a displacing device, whereby
the climate control device can be displaced between an operating position arranged in the charging station and at least one maintenance position, which is arranged at least in some regions outside of the charging station, by means of the displacing device, whereby
in the operating position, the air outlet connection is releasably connected fluidically to the air entrance, and the air inlet connection to the air exit, whereby
in the at least one maintenance position, the air outlet connection is released from the air entrance and the air inlet connection from the air exit, in particular fluidically separated.

11. The charging station according to claim 10, whereby
the air outlet connection and the air entrance are configured to be fluidically connected to one another during a displacement of the climate control device into the operating position, and in order to be released from one another, in particular fluidically separated, during a displacement of the climate control device away from the operating position, whereby
the air inlet connection and the air exit are configured to be fluidically connected to one another during a displacement of the climate control device into the operating position, and in order to be released from one another, in particular fluidically separated, during a displacement of the climate control device away from the operating position.

12. The charging station according to claim 8, whereby
a first sealing element is arranged between the air outlet connection and the air entrance, whereby the first sealing element is optionally fastened to the air outlet connection or to the air entrance, whereby
a second sealing element is arranged between the air inlet connection and the air exit, whereby the second sealing element is optionally fastened to the air inlet connection or to the air exit.

13. The charging station according to claim 8, whereby the air region separating element of the air guiding device is formed as a support structure of the charging station, which is configured to mechanically stabilize the charging station.

14. The charging station according to claim 13, whereby the air region separating element is arranged diagonally to the first base surface and/or to the second base surface.
